(19) United States
(12) Patent Application Publication
(10) Pub. No.: US 2017/0109584 A1
(43) Pub. Date: Apr. 20, 2017

(54) Video Highlight Detection with Pairwise Deep Ranking

(71) Applicant: Microsoft Technology Licensing, LLC, Redmond, WA (US)

(72) Inventors: Ting Yao, Beijing (CN); Tao Mei, Beijing (CN); Yong Rui, Sammamish, WA (US)

(21) Appl. No.: 14/887,629

(22) Filed: Oct. 20, 2015

(51) Int. Cl. G06K 9/00; G11B 27/30; G11B 27/031

(52) U.S. Cl. CPC G06K 9/00718; G11B 27/031; G11B 27/3081; G06K 9/00751

(57) ABSTRACT

Video highlight detection using pairwise deep ranking neural network training is described. In some examples, highlights in a video are discovered, then used for generating summarization of videos, such as first-person videos. A pairwise deep ranking model is employed to learn the relationship between previously identified highlight and non-highlight video segments. This relationship is encapsulated in a neural network. An example two stream process generates highlight scores for each segment of a user's video. The obtained highlight scores are used to summarize highlights of the user's video.

### BACKGROUND

The emergence of wearable devices such as portable cameras and smart glasses makes it possible to record life logging first-person videos. For example, wearable camcorders such as Go-Pro cameras and Google Glass are now able to capture high quality first-person videos for recording our daily experience. These first-person videos are usually extremely unstructured and long-running. Browsing and editing such videos is a very tedious job. Video summarization applications, which produce a short summary of a full-length video that encapsulate most informative parts alleviate many problems associated with first-person video browsing, editing and indexing.

The research on video summarization has mainly proceeded along two dimensions, i.e., keyframe or shot-based, and structure-driven approaches. The keyframe or shot-based method selects a collection of keyframes or shots by optimizing diversity or representativeness of a summary, while structure-driven approach exploits a set of well-defined structures in certain domains (e.g., audience cheering, goal or score events in sports videos) for summarization. In general, existing approaches offer sophisticated ways to sample a condensed synopsis from the original video, reducing the time required for users to view all the contents.

However, defining video summarization as a sampling problem in conventional approaches is very limited as users' interests in a video are overlooked. As a result, the special moments are often omitted due to the visual diversity criteria of excluding redundant parts in a summary. The limitation is particularly severe when directly applying those methods to first-person videos, because these videos are recorded in unconstrained environments, making them long, redundant and unstructured.

### SUMMARY

This document describes a facility for video highlight detection using pairwise deep ranking neural network training.

In some examples, major or special interest (i.e. highlights) in a video are discovered for generating summarization of videos, such as first-person videos. A pairwise deep ranking model can be employed to learn the relationship between previously identified highlight and non-highlight video segments. A neural network encapsulates this relationship. An example system develops a two-stream network structure video highlight detection by using the neural network. The two-stream network structure can include complementary information on appearance of video frames and motion between frames of video segments. The two streams can generate highlight scores for each segment of a user's video. The system uses the obtained highlight scores to summarize highlights of the user's video by combining the highlight scores for each segment into a single segment score. Example summarizations can include video time-lapse and video skimming The former plays the highlight segments with high scores at low speed rates and non-highlight segments with low scores at high speed rates, while the latter assembles the sequence of segments with the highest scores (or scores greater than a threshold).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The terms “techniques” for instance, may refer to method(s) and/or computer-executable instructions, module(s), algorithms, hardware logic (e.g., Field-programmable Gate Arrays (FPGAs), Application-Specific Integrated Circuits (ASICs), Application-Specific Standard Products (ASSPs), System-on-a-chip systems (SOCs), Complex Programmable Logic Devices (CPLDs)), and/or “facility,” for instance, may refer to hardware logic and/or other system(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a pictorial diagram of an example of an environment for performing video highlight detection.

FIG. 2 is a pictorial diagram of part of an example consumer device from the environment of FIG. 1.

FIG. 3 is a pictorial diagram of an example server from the environment of FIG. 1.

FIG. 4 is a block diagram that illustrates an example neural network training process.

FIGS. 5-1 and 5-2 show an example highlight detection process.

FIG. 6 shows a flow diagram of an example process for implementing highlight detection.

FIG. 7 shows a flow diagram of a portion of the process shown in FIG. 6.

FIG. 8 shows a flow diagram of an example process for implementing highlight detection.

FIG. 9 is a graph showing performance comparisons with other highlight detection techniques.

### DETAILED DESCRIPTION

Concepts and technologies are described herein for presenting a video highlight detection system for producing outputs to users for accessing highlighted content of large streams of video.

### Overview

Current systems that provide highlight of video content do not have the ability to effectively identify spatial moments in a video stream. The emergence of wearable devices such as portable cameras and smart glasses makes it possible to record life logging first-person videos. Browsing such long unstructured videos is time-consuming and tedious.

In some examples, the technology described herein describes moments of major interest or special interest (e.g., highlights) in a video (e.g., first-person video) for generating the summarizations of the videos.

In one example, a system uses a pair-wise deep ranking model that employs deep learning techniques to learn the relationship between highlight and non-highlight video segments. The results of the deep learning can be a trained neural network(s). A two-stream network structure can determine a highlight score for each video segment of a user identified video based on the trained neural network(s). The system uses the highlight scores for generating output summarization. Example output summarizations can include at least video time-lapse or video skimming The former plays the segments having high scores at low speeds and the segments having low scores at high speed, while the latter assembles the sequence of segments with the highest scores.

The following detailed description refers to the accompanying drawings. Wherever possible, the same reference numbers are used in the drawing and the following description to refer to the same or similar elements. While an example may be described, modifications, adaptations, and other examples are possible. For example, substitutions, additions, or modifications may be made to the elements illustrated in the drawings, and the methods described herein may be modified by substituting, reordering, or adding stages to the disclosed methods. Accordingly, the following detailed description does not provide limiting disclosure, but instead, the proper scope is defined by the appended claims

### Example

Referring now to the drawings, in which like numerals represent like elements, various examples will be described.

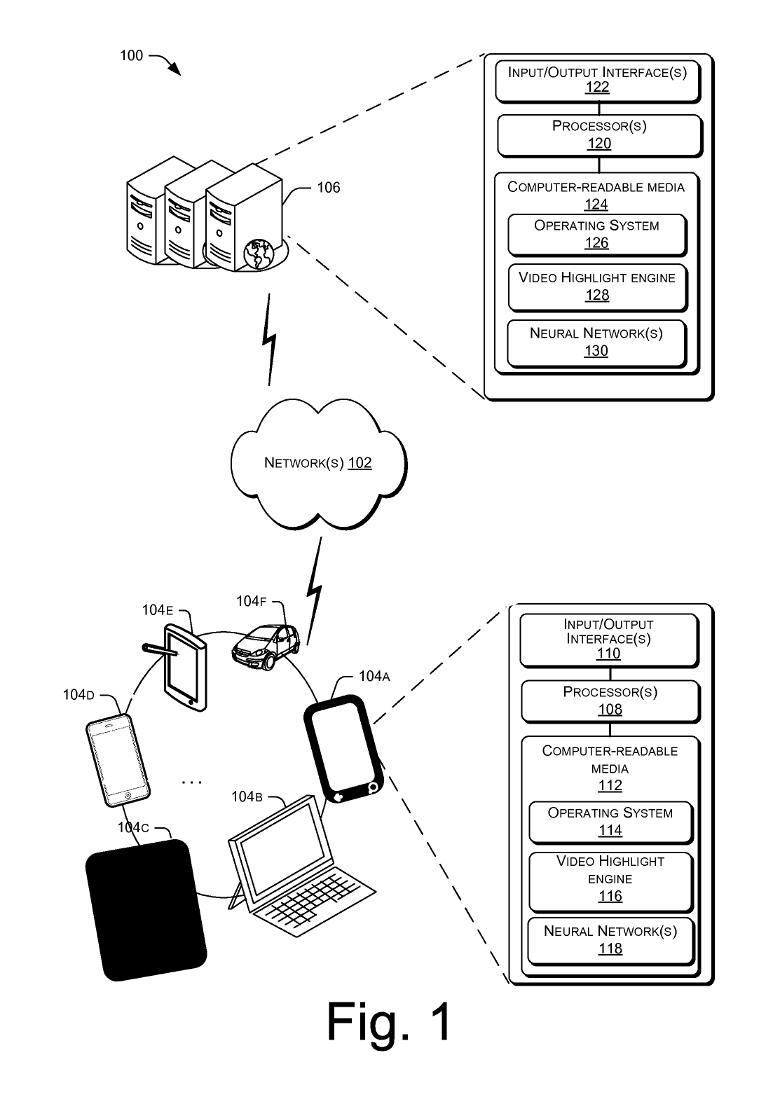

The architecture described below constitutes but one example and is not intended to limit the claims to any one particular architecture or operating environment. Other architectures may be used without departing from the spirit and scope of the claimed subject matter. FIG. 1 is a diagram of an example environment for implementing video highlight detection and output based on the video highlight detection.

In some examples, the various devices and/or components of environment 100 include one or more network(s) 102 over which a consumer device 104 may be connected to at least one server 106. The environment 100 may include multiple networks 102, a variety of consumer devices 104, and/or one or more servers 106.

In various examples, server(s) 106 can host a cloud-based service or a centralized service particular to an entity such as a company. Examples support scenarios where server(s) 106 can include one or more computing devices that operate in a cluster or other grouped configuration to share resources, balance load, increase performance, provide fail-over support or redundancy, or for other purposes over network 102. Server(s) 106 can belong to a variety of categories or classes of devices such as traditional server-type devices, desktop computer-type devices, mobile devices, special purpose-type devices, embedded-type devices, and/or wearable-type devices. Server(s) 106 can include a diverse variety of device types and are not limited to a particular type of device. Server(s) 106 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device.

For example, network(s) 102 can include public networks such as the Internet, private networks such as an institutional and/or personal intranet, or some combination of private and public networks. Network(s) 102 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. Network(s) 102 can utilize communications protocols, including packet-based and/or datagram-based protocols such as internet protocol (IP), transmission control protocol (TCP), user datagram protocol (UDP), or other types of protocols. Moreover, network(s) 102 can also include a number of devices that facilitate network communications and/or form a hardware basis for the networks, such as switches, routers, gateways, access points, firewalls, base stations, repeaters, backbone devices, and the like.

In some examples, network(s) 102 can further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), and other standards.

In various examples, consumer devices 104 include devices such as devices 104A-104G. Examples support scenarios where device(s) 104 can include one or more computing devices that operate in a cluster or other grouped configuration to share resources or for other purposes. Consumer Device(s) 104 can belong to a variety of categories or classes of devices such as traditional client-type devices, desktop computer-type devices, mobile devices, special purpose-type devices, embedded-type devices and/or wearable-type devices. Although illustrated as a diverse variety of device types, device(s) 104 can be other device types and are not limited to the illustrated device types. Consumer device(s) 104 can include any type of computing device with one or multiple processor(s) 108 operably connected to an input/output (I/O) interface(s) 110 and computer-readable media 112. Consumer devices 104 can include computing devices such as, for example, smartphones 104A, laptop computers 104B, tablet computers 104C, telecommunication devices 104D, personal digital assistants (PDAs) 104E, automotive computers such as vehicle control systems, vehicle security systems, or electronic keys for vehicles (e.g., 104F, represented graphically as an automobile), a low-resource electronic device (e.g., IoT device) 104G and/or combinations thereof. Consumer devices 104 can also include electronic book readers, wearable computers, gaming devices, thin clients, terminals, and/or work stations. In some examples, consumer devices 104 can be desktop computers and/or components for integration in a computing device, appliances, or another sort of device. Consumer devices 104 can include

In some examples, as shown regarding consumer device 104A, computer-readable media 112 can store instructions executable by processor(s) 108 including operating system 114, video highlight engine 116, and other modules, programs, or applications, such as neural network(s) 118, that are loadable and executable by processor(s) 108 such as a central processing unit (CPU) or a graphics processing unit (GPU). Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Consumer device(s) 104 can further include one or more I/O interfaces 110 to allow a consumer device 104 to communicate with other devices. I/O interfaces 110 of a consumer device 104 can also include one or more network interfaces to enable communications between computing consumer device 104 and other networked devices such as other device(s) 104 and/or server(s) 106 over network(s) 102. I/O interfaces 110 of a consumer device 104 can allow a consumer device 104 to communicate with other devices such as user input peripheral devices (e.g., a keyboard, a mouse, a pen, a game controller, an audio input device, a visual input device, a touch input device, gestural input device, and the like) and/or output peripheral devices (e.g., a display, a printer, audio speakers, a haptic output, and the like). Network interface(s) can include one or more network interface controllers (NICs) or other types of transceiver devices to send and receive communications over a network.

Server(s) 106 can include any type of computing device with one or multiple processor(s) 120 operably connected to an input/output interface(s) 122 and computer-readable media 124. Multiple servers 106 can distribute functionality, such as in a cloud-based service. In some examples, as shown regarding server(s) 106, computer-readable media 124 can store instructions executable by the processor(s) 120 including an operating system 126, video highlight engine 128, neural network(s) 130 and other modules, programs, or applications that are loadable and executable by processor(s) 120 such as a CPU and/or a GPU. Alternatively, or in addition, the functionally described herein can be performed, at least in part, by one or more hardware logic components. For example, and without limitation, illustrative types of hardware logic components that can be used include FPGAs, ASICs, ASSPs, SOCs, CPLDs, etc.

Server(s) 106 can further include one or more I/O interfaces 122 to allow a server 106 to communicate with other devices such as user input peripheral devices (e.g., a keyboard, a mouse, a pen, a game controller, an audio input device, a video input device, a touch input device, gestural input device, and the like) and/or output peripheral devices (e.g., a display, a printer, audio speakers, a haptic output, and the like). I/O interfaces 110 of a server 106 can also include one or more network interfaces to enable communications between computing server 106 and other networked devices such as other server(s) 106 or devices 104 over network(s) 102.

Computer-readable media 112, 124 can include, at least, two types of computer-readable media, namely computer storage media and communications media.

Computer storage media 112, 124 can include volatile and non-volatile, removable and non-removable media implemented in any method or technology for storage of information such as computer readable instructions, data structures, program modules, or other data. Computer storage media can include tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium or memory technology or any other non-transmission medium that can be used to store and maintain information for access by a computing device.

In contrast, communication media may embody computer-readable instructions, data structures, program modules, or other data in a modulated data signal, such as a carrier wave, or other transmission mechanism.

As defined herein, computer storage media does not include communication media exclusive of any of the hardware components necessary to perform transmission. That is, computer storage media does not include communications media consisting solely of a modulated data signal, a carrier wave, or a propagated signal, per se.

Server(s) 106 can include programming to send a user interface to one or more device(s) 104. Server(s) 106 can store or access a user profile, which can include information a user has consented the entity to collect such as a user account number, name, location, and/or information about one or more consumer device(s) 104 that the user can use for sensitive transactions in untrusted environments.

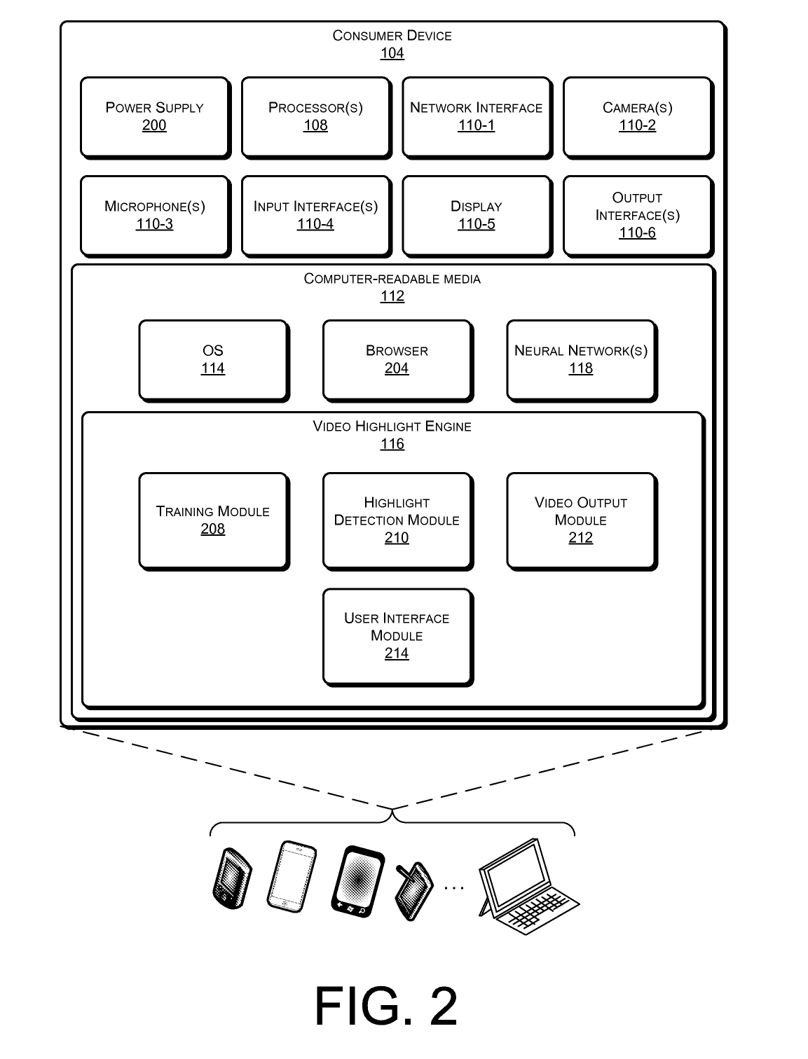

FIG. 2 illustrates select components of an example consumer device 104 configured to detect highlight video and present the highlight video. An example consumer device 104 can include a power supply 200, one or more processors 108 and I/O interface(s) 110. I/O interface(s) 110 can include a network interface 110-1, one or more cameras 110-2, one or more microphones 110-3, and in some instances additional input interface 110-4. The additional input interface(s) can include a touch-based interface and/or a gesture-based interface. Example consumer device 104 can also include a display 110-5 and in some instances can include additional output interface 110-6 such as speakers, a printer, etc. Network interface 110-1 enables consumer device 104 to send and/or receive data over network 102. Network interface 110-1 can also represent any combination of other communication interfaces to enable consumer device 104 to send and/or receive various types of communication, including, but not limited to, web-based data and cellular telephone network-based data. In addition example consumer device 104 can include computer-readable media 112. Computer-readable media 112 can store operating system (OS) 114, browser 204, neural network(s) 118, video highlight engine 116 and any number of other applications or modules, which are stored as computer-readable instructions, and are executed, at least in part, on processor 108.

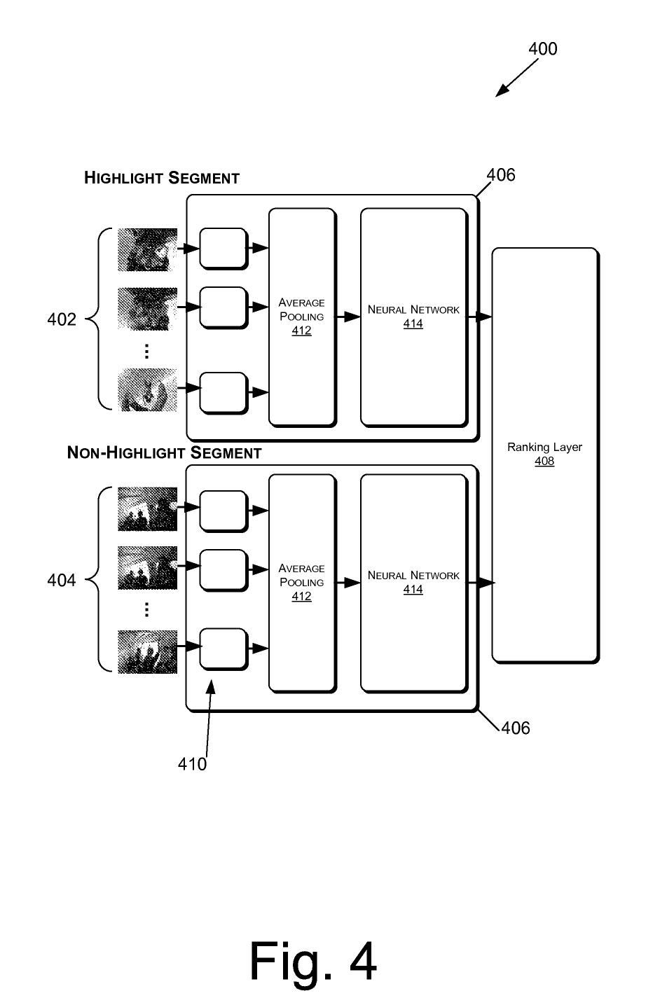

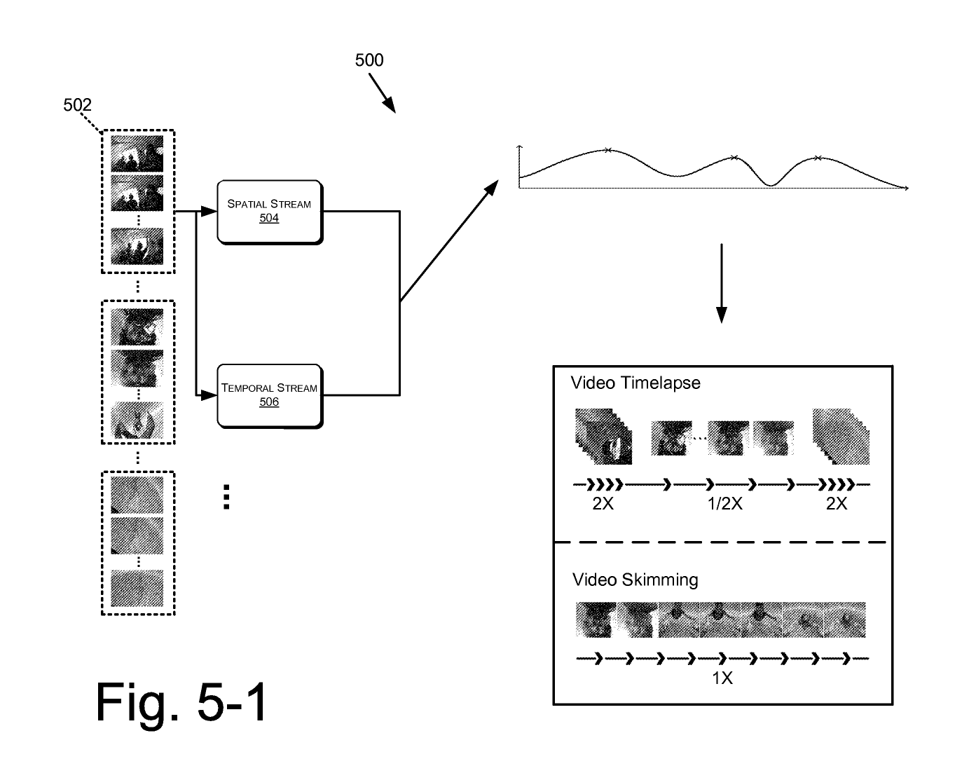

Video highlight engine 116 can include training module 208, highlight detection module 210, video output module 212 and user interface module 214. Training module 208 can train and store neural networks(s) using other video content having previously identified highlight and non-highlight video segments. Neural network training is described by the example shown in FIG. 4.

Highlight detection module 210 can detect highlight scores for numerous segments from a client identified video stream using the trained neural network(s). Highlight detection is described by example in FIGS. 5-1, 5-2.

Video output module 212 can summarize the client/customer identified video stream by organizing segments of the video stream and outputting the segments based on the segment highlight scores and/or the organization.

User interface module 214 can interact with I/O interfaces(s) 110. User interface module 214 can present a graphical user interface (GUI) at I/O interface 110. GUI can include features for allowing a user to interact with training module 208, highlight detection module 210, video output module 212 or components of video highlight engine 128. Features of the GUI can allow a user to train neural network(s), select video for analysis and view summarization of analyzed video at consumer device 104.

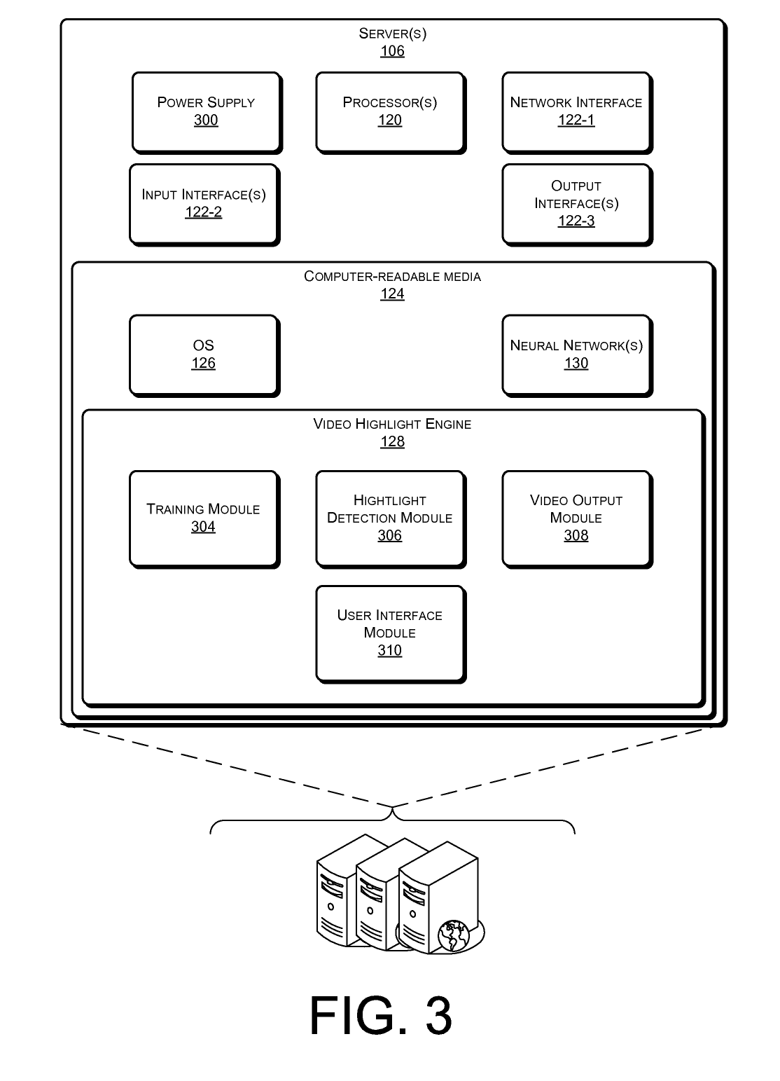

FIG. 3 is a block diagram that illustrates select components of an example server device 106 configured to provide highlight detection and output as described herein. Example server 106 can include a power supply 300, one or more processors 120 and I/O interfaces corresponding to I/O interface 122 including a network interface 122-1, and in some instances may include one or more additional input interfaces 122-2, such as a keyboard, soft keys, a microphone, a camera, etc. In addition, I/O interface 122 can also include one or more additional output interfaces 122-3 including output interfaces such as a display, speakers, a printer, etc. Network interface 122-1 can enable server 106 to send and/or receive data over network 102. Network interface 122-1 may also represent any combination of other communication interfaces to enable server 106 to send and/or receive various types of communication, including, but not limited to, web-based data and cellular telephone network-based data. In addition example server 106 can include computer-readable media 124. Computer-readable media 124 can store an operating system (OS) 126, a video highlight engine 128, neural network(s) 130 and any number of other applications or modules, which are stored as computer-executable instructions, and are executed, at least in part, on processor 120.

Video highlight engine 128 can include training module 304, highlight detection module 306, video output module 308 and user interface module 310. Training module 304 can train and store neural networks(s) using previously identified video with previously identified highlight and non-highlight segments. Neural network training is described by the example shown in FIG. 4. Training module 304 can be similar to training module 208 at consumer device 104, can include components that compliment training module 208 or can be unique versions.

Highlight detection module 306 can detect highlight scores for numerous segments from a client identified video stream using the trained neural network(s). Highlight detection module 306 can be similar to highlight detection module 210 located at consumer device 104, can include components that compliment highlight detection module 210 or can be unique versions.

Video output module 308 can summarize the client/customer identified video stream by organizing segments of the video stream and outputting of the segments based on the segment highlight scores. User interface module 310 can interact with I/O interfaces(s) 122 and with I/O interfaces(s) 110 of consumer device 104. User interface module 310 can present a GUI at I/O interface 122. GUI can include features for allowing a user to interact with training module 304, highlight detection module 306, video output module 308 or other components of video highlight engine 128. The GUI can be presented in a website for presentation to users at consumer device 104.

### Example Operation

FIGS. 4-6 illustrate example processes for implementing aspects of highlighting video segments for output as described herein. These processes are illustrated as collections of blocks in logical flow graphs, which represent a sequence of operations that can be implemented in hardware, software, or a combination thereof. In the context of software, the blocks represent computer-executable instructions on one or more computer-readable media that, when executed by one or more processors, cause the processors to perform the recited operations.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Note that the order in which the processes are described is not intended to be construed as a limitation, and any number of the described process blocks can be combined in any order to implement the processes, or alternate processes. Additionally, individual blocks may be deleted from the processes without departing from the spirit and scope of the subject matter described herein. Furthermore, while the processes are described with reference to consumer device 104 and server 106 described above with reference to FIGS. 1-3, in some examples other computer architectures including other cloud-based architectures as described above may implement one or more portions of these processes, in whole or in part.

### Training

FIG. 4 shows an example process 400 for defining spatial and temporal deep convolutional neural network (DCNN) architectures as performed by processor 108 and/or 120 that is executing training module 208 and/or 304. Process 400 illustrates a pairwise deep ranking model used for training spatial and temporal DCNN architectures for use in predicting video highlights for other client selected video streams. Processor 108 and/or 120 can use a pair of previously identified highlight and non-highlight spatial video segments as input for optimizing spatial DCNN architecture. Each pair can include a highlight video segment hᵢ 402 and a non-highlight segment nᵢ 404 from the same video. Processor 108 and/or 120 can separately feed the two segments 402, 404 into two identical spatial DCNNs 406 with shared architecture and parameters. The spatial DCNNs 406 can include classifier 410 that identifies a predefined number of classes for each frame of an inputted segment. In this example, classifier 410 can identify 1000 classes or 1000 point dimensional feature vector for each frame sample of a video segment. Classifier 410 can identify less or more classes for an input. The number of classes may be dependent upon the number of input nodes of a neural network included in the DCNN. Classifier 410 can be considered a feature extractor. The input is video frame and the output is 1000 dimensional feature vector. Each element of the feature vector denotes the probability that the frame belongs to each class. The 1000 dimensional vector can represent each frame. Other numbers of classes or sized dimensional vectors can be used. An example classifier is AlexNet created by Alex Krizhevsky et al.

At block 412, processor 108 and/or 120 can average the classes for all the frames of a segment to produce an average pooling value. Processor 108 and/or 120 feeds the average pooling value into a respective one of two identical neural networks 414. The neural networks 414 can produce highlight scores—one for the highlight segment and one for the non-highlight segment.

Processor 108 and/or 120 can feed the highlight scores into ranking layer 408. The output highlight scores exhibit a relative ranking order for the video segments. Ranking layer 408 can evaluate the margin ranking loss of each pair of segments. In one example, ranking loss can be:

min:Σ₍ₕ_{ᵢ}_{,n}_{ᵢ}_{)∈P}max(0, 1−f(hᵢ)+f(nᵢ)) (1)

During learning, ranking layer 408 can evaluate violations of the ranking order. When the score of the highlight segment has a lower highlight score than the non-highlight segment, processor 108 and/or 120 adjusts parameters of the neural network 414 to minimize the ranking loss. For example, gradients are back-propagated to lower layers so that the lower layers can adjust their parameters to minimize ranking loss. Ranking layer 408 can compute the gradient of each layer by going layer-by-layer from top to bottom.

The process of temporal DCNN training can be performed in a manner similar to spatial DCNN training described above. The input 402, 404 for temporal DCNN training can include optical flows for a video segment. An example definition of optical flow includes a pattern of apparent motion of objects, surfaces and/or edges in a visual scene caused by relative motion between a camera and a scene.

### Highlight Detection

FIGS. 5-1 and 5-2 show process 500 that illustrates two-stream DCNN with late fusing for outputting highlight scores for video segments of an inputted video and using the highlight scores to generate a summarization for the inputted video. First, processor 108 and/or 120 can decompose the inputted video into spatial and temporal components. Spatial and temporal components relate to ventral and dorsal streams for human perception respectively. The ventral stream plays a major role in the identification of objects, while the dorsal stream mediates sensorimotor transformations for visually guided actions of objects in the scene. The spatial component depicts scenes and objects in the video by frame appearance while the temporal part conveys the movement in the form of motion between frames.

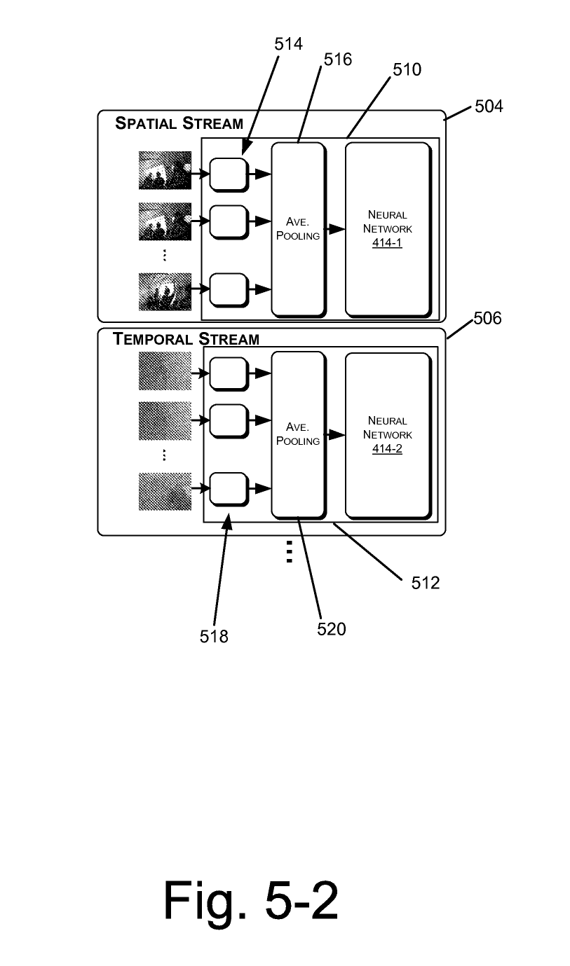

Given an input video 502, processor 108 and/or 120 can delimit a set of video segments by performing uniform partition in temporal, shot boundary detection, or change point detection algorithms. An example partition can be 5 seconds. A set of segments may include frames sampled at a rate of 3 frames/second. This results in 15 frames being used for determining a highlight score for a segment. Other partitions and sample rates may be used depending upon a number of factors including, but not limited to, processing power or time. For each video segment, spatial stream 504 and temporal stream 506 operate on multiple frames extracted in the segment to generate a highlight score for the segment. For each video segment, spatial DCNN operates on multiple frames. The first stage is to extract the representations of each frame by classifier 410. Then, an average pooling 412 can get the representations of each video segment for all the frames. The resulting representations of video segment forms the input to spatial neural network 414 and the output of spatial neural network 414 is the highlight score of spatial DCNN. The highlight score generation of temporal DCNN is similar to spatial DCNN. The only difference is that the input of spatial DCNN is video frame while the input of temporal DCNN is optical flow. Finally, a weighted average of the two highlight scores of spatial and temporal DCNN forms a highlight score of the video segment. Streams 504, 506 repeat highlight score generation for other segments of the inputted video. Spatial stream 504 and temporal stream 506 can weight highlight scores associated with a segment. Process 500 can fuse the weighted highlight scores for a segment to form a score of the video segment. Process 500 can repeat the fusing for other video segments of the inputted video. Streams 504, 506 are described in more detail in FIG. 5-2.

Graph 508 is an example of highlight scores for segments of an inputted video. Process 500 can use graph 508 or data used to create graph 508 to generate a summarization, such as time-lapse summarization or a skimming summarization.

As shown in FIG. 5-2, spatial stream 504 can include spatial DCNN 510 that can be architecturally similar to the DCNN 406 shown in FIG. 4. Also, temporal stream 506 includes temporal DCNN 512 that can be architecturally similar to the DCNN 406 shown in FIG. 4. DCNN 510 can include a spatial neural network 414-1 that was spatially trained by process 400 described in FIG. 4. DCNN 512 includes a temporal neural network 414-2 that was temporally trained by process 400 described in FIG. 4. An example architecture of neural network(s) 414 can be F1000-F512-F256-F128-F64-F1, F1000-F512-F256-F128-F64-F1, which contains six fully-connected layers layers (denoted by F with the number of neurons). The output of the last layer is the highlight score for the segment being analyzed.

Unlike the spatial DCNN 510, the input to temporal DCNN 512 can include multiple optical flow “images” between several consecutive frames. Such inputs can explicitly describe the motion between video frames of a segment. In one example, a temporal component can compute and convert the optical flow into a flow “image” by centering horizontal (x) and vertical (y) flow values around 128 and can multiply the flow values by a scalar value such that the flow values fall between 0 and 255, for example. The transformed x and y flows are the first two channels for the flow image and the third channel can be created by calculating the flow magnitude. Furthermore, to suppress the optical flow displacements caused by camera motion, which are extremely common in first person videos, the mean vector of each flow estimates a global motion component. Temporal component subtracts the global motion component from the flow. Spatial DCNN 510 can fuse the outputs of classification 514 and averaging 516, followed by importing into the trained neural network 414-1 for generating a spatial highlight score. Temporal DCNN 512 can fuse the outputs of classification 518 and averaging 520, followed by importing into the trained neural network 414-2 for generating a temporal highlight score.

Process 500 can late fuse the spatial highlight score and the temporal highlight score from DCNNs 510, 512, thus producing a final highlight score for the video segment. Fusing can include applying a weight value to each highlight score, then adding the weighted values to produce the final highlight score. Process 500 can combine the final highlight scores for the segments of the inputted video to form highlight curve 508 for the whole inputted video. The video segments with high scores (e.g., scores above a threshold) are selected as video highlights accordingly. Other streams (e.g., audio stream) may be used with or without the spatial and temporal streams previously described.

In one example, highlight detection module 210, 306 use only one of the streams 504, 506 can be used for generating highlight scores.

### Output

In some examples, video output module 212, 308 can generate various outputs using the highlight scores for the segments of inputted video. The various outputs provide various summarizations of highlights of the inputted video. An example video summarization technique can include time-lapse summarization. The time-lapse summarization can increase the speed of non-highlight video segments by selecting every r^{th} frame and showing highlight segments in slow motion.

Let Lᵥ, Lₕ and Lₙ be the length of original video, highlight segments and non-highlight segments, respectively. Lₕ<<Lₙ, Lᵥ. r is the rate of decelerating. Given a maximum length of L, rate r is as follows:

$${rL}_{h} + \frac{1}{r} L \leq L \qquad ( 2 )$$

Since Lₕ+Lₙ=Lᵥ,

$$r = ⌊ \frac{L}{2 {L}_{h}} + \sqrt{Y} ⌋$$

where

$$Y = \frac{{L}^{2} - 4 {L}_{v} {L}_{h} + 4 {L}_{h}^{2}}{4 {L}_{h}^{2}} .$$

In this example, video output module 212, 308 can generate a video summary by compressing the non-highlight video segments while expanding the highlight video segments.

Another highlight summarization can include video skimming summarization. Video skimming provides a short summary of original video, which includes all the important/highlight video segments. First, video skimming performs a temporal segmentation, followed by singling out of a few segments to form an optimal summary in terms of certain criteria, e.g., interestingness and importance. Temporal segmentation splits the whole video into a set of segments.

An example video skimming technique is described as follows. Let a video be composed of a sequence of frames xᵢ ∈ X (i=0, . . . , m−1), where xᵢ is the visual feature of the i^{h} frame. Let K:X×X→R be a kernel function between visual features. Denote φ:X→H as a feature map, where H and |·|_{H} are mapped feature space and a norm in the feature space, respectively. Temporal segmentation can find a set of optimal change points/frames as the boundaries of segments and the optimization is given by

$${min}_{c \text{:} {t}_{0} , … , {t}_{C - 1}} \text{:} {G}_{m , c} + λ q ( m , c ) \qquad ( 3 )$$

where c is the number of change points. G_{m,c} measures the overall within segment kernel variances dₜ_{ᵢ}_{,t}_{ᵢ₊₁}, and is computed as

G_{m,c}=Σᵢ₌₀^{c}dₜ_{_{i−1}}_{,t}_{ᵢ} (4)

where

$${d}_{{t}_{i - 1} , {t}_{i}} = {\sum }_{T = {T}_{I}}^{{T}_{I + 1} - 1} {‖ φ ( {X}_{T} ) - {μ}_{I} ‖}_{H}^{2} and {μ}_{i} = \frac{{\sum }_{t = {t}_{i}}^{{t}_{i + 1} - 1} φ ( {x}_{t} )}{{t}_{i + 1} - {t}_{i}}$$

q(m, c) is a penalty term, which penalizes segmentations with too many segments. In one example, a Bayesian information criterion (BIC)-type penalty with the parameterized form q(m, c)=c(log(m/c)+1). Parameter λ weights the importance of each term. The objective of Eq. (3) yields a trade-off between under-segmentation and over-segmentation. In one example, dynamic programming can minimize an objective in Eq. (4) and iteratively compute the optimal number of change points. A backtracking technique can identify a final segmentation.

After the segmentation, highlight detection can be applied to each video segment, producing the highlight score. Given the set of video segments S={s₁, . . . , s_{c}} and each segment can be associated with a highlight score f(sᵢ), a subset with a length below a maximum L and a sum of the highlight scores can be maximized. Specifically, the problem can be defined as

$${max}_{b} \text{:} {\sum }_{i = 1}^{c} {b}_{i} f ( {s}_{i} ) s . t . {\sum }_{i = 1}^{c} {b}_{i} \vert {s}_{i} \vert \leq L , \qquad ( 5 )$$

where bᵢ ∈ {0, 1} and bᵢ=1 indicates that the i^{th} segment is selected. |sᵢ| is the length of the i^{th} segment.

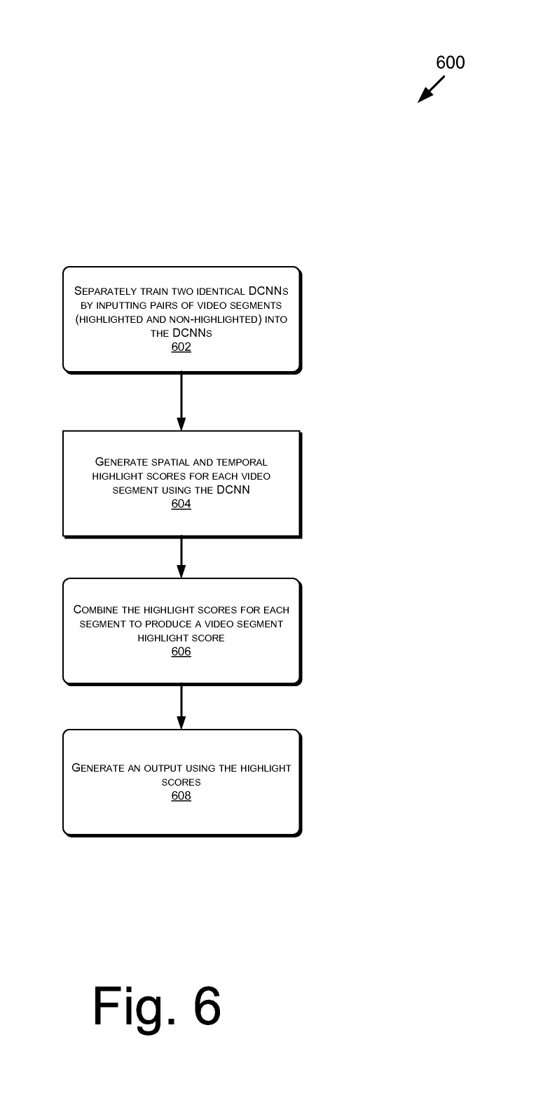

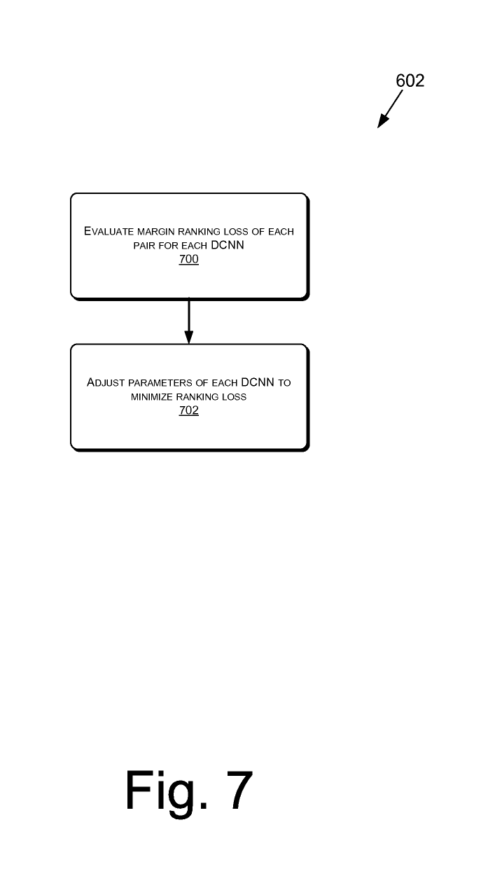

FIG. 6 illustrates an example process 600 for identifying highlight segments from an input video stream. At block 602, two DCNNs are trained. The two DCNNs receive pairs of video segments previously identified as having highlight and non-highlight video content as input. Process 600 can train different DCNNs depending upon the type of inputted video segments (e.g., spatial and temporal). In one example, the result includes a trained spatial DCNN and a trained temporal DCNN. Training can occur offline separate from execution of other portions of process 600. FIG. 7 shows an example of DCNN training.

At block 604, highlight detection module 210 and/or 306 can generate highlight scores for each video segment of an inputted video stream using the trained DCNNs. In one example, highlight detection module 210 and/or 306 can separately generate spatial and temporal highlight scores using previously trained spatial and temporal DCNNs.

At block 606, highlight detection module 210 and/or 306 may determine two highlight scores for each segment. Highlight detection module 210 and/or 306 may add weighting to at least one of the scores before combining the scores to create a highlight score for a segment. The completion of score determination for all the segments of inputted video may produce a video highlight score chart (e.g., 508).

At block 608, video output module 212 and/or 308 may generate a video summarization output using at least a portion of the highlight scores. The basic strategy generates the summarization based on the highlight scores. After the highlight score for each video segment is attained, skip over of the non-highlight segments (segments with low highlight scores) occurs and/or play the highlight (non-highlight) segments at low (high) speed rates.

Example video summarization outputs may include video time-lapse and video skimming as described previously.

FIG. 7 illustrates an example execution of block 602. At block 700, margin ranking loss of each pair of video segments inputted for each DCNN is evaluated. Margin ranking loss is a determination of whether the results produced by the DCNNs properly rank the highlight segments relative to the non-highlight segments. For example, if a highlight segment has a lower ranking than a non-highlight segment, then a ranking error has occurred.

Then, at block 702, parameters of each DCNN are adjusted to minimize ranking loss. Blocks 700 and 702 can repeat a predefined number of times in order to iteratively improve the results of the ranking produced by the DCNNs. Alternatively, blocks 700 and 702 can repeat until ranking results meet a predefined ranking error threshold.

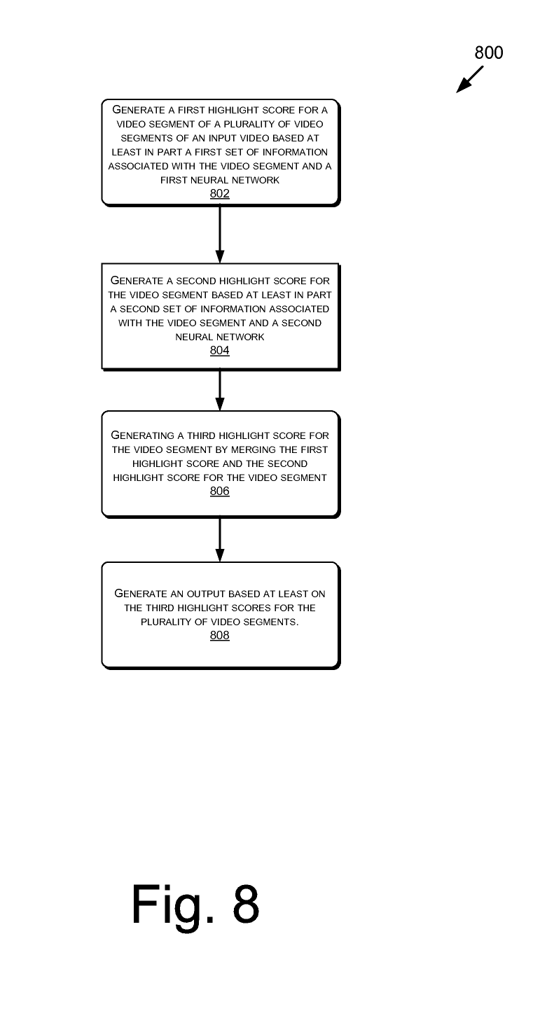

FIG. 8 illustrates an example process 800 for identifying highlight segments from an input video stream. At a block 802, a computing device generates a first highlight score for a video segment of a plurality of video segments of an input video based at least in part on a first set of information associated with the video segment and a first neural network. At a block 804, the computing device generates a second highlight score for the video segment based at least in part on a second set of information associated with the video segment and a second neural network. At a block 806, the computing device generates a third highlight score for the video segment by merging the first highlight score and the second highlight score for the video segment. At a block 808, the computing device generates an output based at least on the third highlight scores for the plurality of video segments.

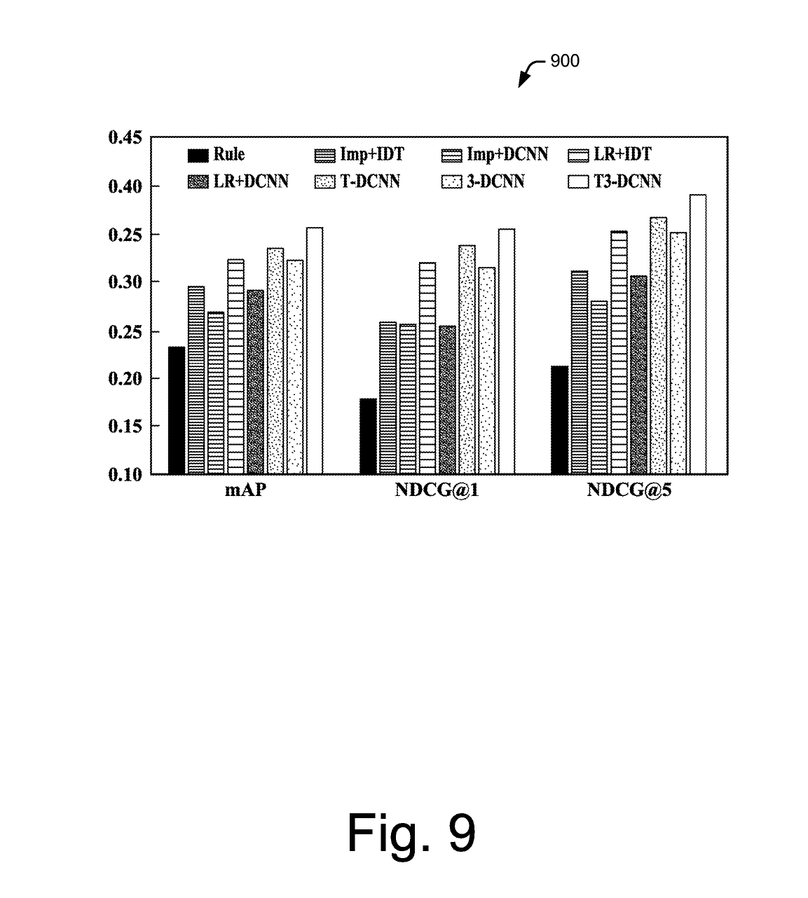

FIG. 9 shows performance comparison of different approaches for highlight detection. Comparison of examples described herein with other approaches show significant improvements. The other approaches for performance evaluation include:
Rule-based model: A test video is first segmented into a series of shots based on color information. Each shot is then decomposed into one or more subshots by a motion threshold-based approach. The highlight score for each subshot is directly proportional to the subshot's length,
Importance-based model (Imp): A linear support vector machine (SVM) classifier per category is trained to score importance of each video segment. For each category, this model uses all the video segments of this category as positive examples and the video segments from the other categories as negatives. This model adopts both improved dense trajectories motion features (IDT) and the average of DCNN frame features (DCNN) for representing each video segment. The two runs based on IDT and DCNN are named as Imp+IDT and Imp+DCNN, respectively.
Latent ranking model (LR): A latent linear ranking SVM model per category is trained to score highlight of each video segment. For each category, all the highlight and non-highlight video segment pairs within each video of this category are exploited for training. Similarly, IDT and the average of DCNN frame features are extracted as the representations of each segment. These two runs are named LR+IDT and LR+DCNN, respectively.
The last three runs are examples presented in this disclosure. Two runs, S-DCNN and T-DCNN, predict the highlight score of video segment by separately using spatial DCNN and temporal DCNN, respectively. The result of TS-DCNN is the weighted summation of S-DCNN and T-DCNN by late fusion.

Evaluation Metrics include calculating the average precision of highlight detection for each video in a test set and mean average precision (mAP) averaging the performance of all test videos is reported. In another evaluation, normalized discounted cumulative gain (NDCG) takes into account the measure of multi-level highlight scores as the performance metric.

Given a segment ranked list for a video, the NDCG score at the depth of d in the ranked list is defined by:

NDCG@D=Z_{d}Σⱼ₌₁^{d}2^{r}^{^{j}}−1/log(1+j)′

where r^{j}={5: as≧8; 4: as=7; 3: as=6; 2: as=5; 1: as≧4} represents the rating of a segment in the ground truth and as denotes the aggregate score of each segment. Zd is a normalization constant and is chosen so that NDCG@d=1 for perfect ranking The final metric is the average of NDCG@D for all videos in the test set.

Overall, the results across different evaluation metrics consistently indicate that the present example leads to a performance boost against other techniques. In particular, the TS-DCNN can achieve 0.3574, which is an improvement over improved dense trajectory using a latent linear ranking model (LR+IDT) by 10.5%. More importantly, the run time of the TS-DCNN is less than LR+IDT by several dozen times in at least one example.

Table 1 listed the detailed run time of each approach on predicting a five minutes' video. Note that the run time of LR+IDT and Imp+IDT, LR+DCNN and Imp+DCNN, TDCNN and TS-DCNN is the same respectively, only one of each is presented in the Table. We see that our method has the best tradeoff between performance and efficiency. Our TS-DCNN finishes in 277 seconds, which is less than the duration of the video. Therefore, our approach is capable of predicting the score while capturing the video, which is potentially to be deployed on mobile devices.

TABLE 1

| App. | Rule | LR + IDT | LR + DCNN | S-DCNN | TS-DCNN |
|---|---|---|---|---|---|
| Time | 25 s | 5 h | 65 s | 72 s | 277 s |

### Example Clauses

A method comprising: generating, at a computing device, a first highlight score for a video segment of a plurality of video segments of an input video based on a first set of information associated with the video segment and a first neural network; generating a second highlight score for the video segment based on a second set of information associated with the video segment and a second neural network; generating a third highlight score for the video segment by merging the first highlight score and the second highlight score for the video segment; and generating an output based at least on the third highlight scores for the plurality of video segments, wherein the first and second sets of information are different, and wherein the first and second neural networks include one or more different parameters.

The method in any of the preceding clauses, further comprising: training the first neural network comprising: generating a highlight segment score by inserting first information associated with a previously identified highlight video segment from another video into a first version of the first neural network; generating a non-highlight segment score by inserting second information associated with a previously identified non-highlight video segment from the other video into a second version of the first neural network, wherein the first and second information have a format similar to the first set of information; comparing the highlight segment score to the non-highlight segment score; and adjusting one or more parameters for the first neural network based on the comparing.

The method in any of the preceding clauses, further comprising: training the second neural network comprising: generating a highlight segment score by inserting first information associated with a previously identified highlight video segment from another video into a first version of the second neural network to generate a highlight segment score; generating a non-highlight segment score by inserting second information associated with a previously identified non-highlight video segment from the other video into a second version of the second neural network, wherein the first and second information have a format similar to the second set of information; comparing the highlight segment score to the non-highlight segment score; and adjusting one or more parameters for the second neural network based on the comparing.

The method in any of the preceding clauses, further comprising: identifying the first set of information by selecting spatial information samples of the video segment; determining a plurality of classification values for the spatial information samples; determining an average of the plurality of classification values; and inserting the average of the plurality of classification values into the first neural network.

The method in any of the preceding clauses, further comprising: identifying the second set of information by selecting temporal information samples of the video segment; determining a plurality of classification values for the temporal information samples; determining an average of the plurality of classification values; and inserting the average of the plurality of classification values into the second neural network.

The method in any of the preceding clauses, further comprising: identifying the first set of information by selecting spatial information samples of the video segment; determining a plurality of classification values for the spatial information samples; determining an average of the plurality of classification values; and inserting the average of the plurality of classification values into the first neural network, and identifying the second set of information by selecting temporal information samples of the video segment; determining a plurality of classification values for the temporal information samples; determining an average of the plurality of classification values for the temporal information samples; and inserting the average of the plurality of classification values for the temporal information samples into the second neural network.

The method in any of the preceding clauses, further comprising: determining a first playback speed for frames of one of the video segments in response to the third highlight score of the one of the video segments being greater than a threshold value; and determining a second playback speed for frames of the one of the video segments in response to the third highlight score of the one of the video segments being less than the threshold value.

The method in any of the preceding clauses, further comprising: determining a playback speed for frames of one of the video segments based at least on the third highlight score of one of the video segments.

The method in any of the preceding clauses, further comprising: identifying video segments having a third highlight score greater than a threshold value; and combining at least a portion of the frames of the video segments identified as having the third highlight score greater than the threshold value.

The method in any of the preceding clauses, further comprising: ordering at least a portion of the frames of at least a portion of the video segments based at least on the third highlight scores of the portion of the video segments.

An apparatus comprising: a processor; and a computer-readable medium storing modules of instructions that, when executed by the processor, configure the apparatus to perform video highlight detection, the modules comprising: a training module to configure the processor to train a neural network based at least on a previously identified highlight segment and a previously identified non-highlight segment, the highlight and non-highlight segments are from a same video; a highlight detection module to configure the processor to generate a highlight score for a video segment of a plurality of video segments from an input video based on a set of information associated with the video segment and the neural network; and an output module to configure the processor to generate an output based at least on the highlight scores for the plurality of video segments.

The apparatus in any of the preceding clauses, wherein the memory stores instructions that, when executed by the processor, further configure the apparatus to: generating a highlight segment score by inserting first information associated with the previously identified highlight video segment into a first neural network, the inserted first information having a format similar to the set of information associated with the video segment; generating a non-highlight segment score by inserting second information associated with the previously identified non-highlight video segment into a second neural network, the inserted second information having a format similar to the set of information associated with the video segment, wherein the first and second neural networks are identical; comparing the highlight segment score to the non-highlight segment score; and adjusting one or more parameters for at least one of the neural networks based on the comparing.

The apparatus in any of the preceding clauses, wherein the memory stores instructions that, when executed by the processor, further configure the apparatus to: identifying the set of information by selecting spatial information samples of the video segment; determining a plurality of classification values for the spatial information samples; determining an average of the plurality of classification values; and inserting the average of the plurality of classification values into the neural network.

The apparatus in any of the preceding clauses, wherein the memory stores instructions that, when executed by the processor, further configure the apparatus to: identifying the set of information by selecting temporal information samples of the video segment; determining a plurality of classification values for the temporal information samples; determining an average of the plurality of classification values; and inserting the average of the plurality of classification values into the neural network.

The apparatus in any of the preceding clauses, wherein the memory stores instructions that, when executed by the processor, further configure the apparatus to: determining a first playback speed for frames of one of the video segments in response to the highlight score of the one of the video segments being greater than a threshold value; and determining a second playback speed for frames of the one of the video segments in response to the highlight score of the one of the video segments being less than the threshold value.

The apparatus in any of the preceding clauses, wherein the memory stores instructions that, when executed by the processor, further configure the apparatus to: identifying video segments having a highlight score greater than a threshold; and combining at least a portion of the frames of the video segments identified as having the highlight score greater than a threshold value.

A system comprising: a processor; and a computer-readable media including instructions that, when executed by the processor, configure the processor to: generate a first highlight score for a video segment of a plurality of video segments of an input video based on a first set of information associated with the video segment and a first neural network; generate a second highlight score for the video segment based on a second set of information associated with the video segment and a second neural network; generate a third highlight score for the video segment by merging the first highlight score and the second highlight score for the video segment; and generate an output based at least on the third highlight scores for the plurality of video segments, wherein the first and second sets of information are different, and wherein the first and second neural networks include one or more different parameters.

The system in any of the preceding clauses, wherein the computer-readable media including instructions that, when executed by the processor, further configure the processor to: train the first neural network comprising: generating a first highlight segment score by inserting first information associated with a previously identified highlight video segment from another video into the first neural network; generating a first non-highlight segment score by inserting second information associated with a previously identified non-highlight video segment from the other video into the first neural network, wherein the first and second information have a format similar to the first set of information; comparing the first highlight segment score to the first non-highlight segment score; and adjusting one or more parameters for the first neural network based on the comparing; and train the second neural network comprising: generating a second highlight segment score by inserting third information associated with a previously identified highlight video segment from the other video into the second neural network; generating a second non-highlight segment score by inserting fourth information associated with a previously identified non-highlight video segment from the other video into the second neural network, wherein the third and fourth information have a format similar to the second set of information; comparing the second highlight segment score to the second non-highlight segment score; and adjusting one or more parameters for the second neural network based on the comparing.

The system in any of the preceding clauses, wherein the computer-readable media including instructions that, when executed by the processor, further configure the processor to identify the first set of information by selecting spatial information samples of the video segment; determine a plurality of classification values for the spatial information samples; determine an average of the plurality of classification values; inserting the average of the plurality of classification values into the first neural network; identify the second set of information by selecting temporal information samples of the video segment; determine a plurality of classification values for the temporal information samples; determine an average of the plurality of classification values for the temporal information samples; and insert the average of the plurality of classification values for the temporal information samples into the second neural network.

The system in any of the preceding clauses, wherein the computer-readable media including instructions that, when executed by the processor, further configure the processor to determine a first playback speed for frames of one of the video segments in response to the third highlight score of the one of the video segments being greater than a first threshold value; and determine a second playback speed for frames of the one of the video segments in response to the third highlight score of the one of the video segments being less than the first threshold value; or identify video segments having a third highlight score greater than a second threshold value; and combine at least a portion of the frames of the video segments identified as having the third highlight score greater than the second threshold value.

A system comprising: a means for generating a first highlight score for a video segment of a plurality of video segments of an input video based on a first set of information associated with the video segment and a first neural network; a means for generating a second highlight score for the video segment based on a second set of information associated with the video segment and a second neural network; a means for generating a third highlight score for the video segment by merging the first highlight score and the second highlight score for the video segment; and a means for generating an output based at least on the third highlight scores for the plurality of video segments, wherein the first and second sets of information are different, and wherein the first and second neural networks include one or more different parameters.

The system in any of the preceding clauses, further comprising: a means for generating a first highlight segment score by inserting first information associated with a previously identified highlight video segment from another video into the first neural network; a means for generating a first non-highlight segment score by inserting second information associated with a previously identified non-highlight video segment from the other video into the first neural network, wherein the first and second information have a format similar to the first set of information; a means for comparing the first highlight segment score to the first non-highlight segment score; and a means for adjusting one or more parameters for the first neural network based on the comparing; and train the second neural network comprising: generating a second highlight segment score by inserting third information associated with a previously identified highlight video segment from the other video into the second neural network; generating a second non-highlight segment score by inserting fourth information associated with a previously identified non-highlight video segment from the other video into the second neural network, wherein the third and fourth information have a format similar to the second set of information; comparing the second highlight segment score to the second non-highlight segment score; and adjusting one or more parameters for the second neural network based on the comparing.

The system in any of the preceding clauses, further comprising a means for identifying the first set of information by selecting spatial information samples of the video segment; a means for determining a plurality of classification values for the spatial information samples; a means for determining an average of the plurality of classification values; a means for inserting the average of the plurality of classification values into the first neural network; a means for identifying the second set of information by selecting temporal information samples of the video segment; a means for determining a plurality of classification values for the temporal information samples; a means for determining an average of the plurality of classification values for the temporal information samples; and a means for inserting the average of the plurality of classification values for the temporal information samples into the second neural network.

The system in any of the preceding clauses, further comprising: a means for determining a first playback speed for frames of one of the video segments in response to the third highlight score of the one of the video segments being greater than a first threshold value; and a means for determining a second playback speed for frames of the one of the video segments in response to the third highlight score of the one of the video segments being less than the first threshold value; or a means for identifying video segments having a third highlight score greater than a second threshold value; and a means for combining at least a portion of the frames of the video segments identified as having the third highlight score greater than the second threshold value.

### Conclusion

Various concept expansion techniques described herein can permit more robust analysis of videos.

Although the techniques have been described in language specific to structural features or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more computing device(s) 104 or 106, such as one or more internal or external CPUs or GPUs, and/or one or more pieces of hardware logic such as FPGAs, DSPs, or other types described above.

All of the methods and processes described above can be embodied in, and fully automated via, software code modules executed by one or more computers or processors. The code modules can be stored in any type of computer-readable medium, memory, or other computer storage device. Some or all of the methods can be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc., can be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternative implementations are included within the scope of the examples described herein in which elements or functions can be deleted, or executed out of order from that shown or discussed, including substantially synchronously or in reverse order, depending on the functionality involved as would be understood by those skilled in the art. It should be emphasized that many variations and modifications can be made to the above-described examples, the elements of which are to be understood as being among other acceptable examples. All such modifications and variations are intended to be included herein within the scope of this disclosure and protected by the following claims

What is claimed is:

1. An apparatus comprising:
a processor; and
a computer-readable medium storing modules of instructions that, when executed by the processor, configure the apparatus to perform video highlight detection, the modules comprising:
a training module to configure the processor to train a neural network based at least on a previously identified highlight segment and a previously identified non-highlight segment, wherein the highlight and non-highlight segments are from a same video;
a highlight detection module to configure the processor to generate a highlight score for a video segment of a plurality of video segments from an input video based at least in part on a set of information associated with the video segment and the neural network; and
an output module to configure the processor to generate an output based at least in part on the highlight scores for the plurality of video segments.

2. The apparatus of claim 1, wherein the training module is further to configure the processor to:
generate a highlight segment score by inserting first information associated with the previously identified highlight video segment into a first neural network, the inserted first information having a format similar to the set of information associated with the video segment;
generate a non-highlight segment score by inserting second information associated with the previously identified non-highlight video segment into a second neural network, the inserted second information having a format similar to the set of information associated with the video segment,
compare the highlight segment score to the non-highlight segment score; and
adjust one or more parameters for at least one of the neural networks based at least in part on the comparing.

3. The apparatus of claim 1, wherein the highlight detection module is further to configure the processor to:
identify the set of information by selecting spatial information samples of the video segment;
determine a plurality of classification values for the spatial information samples;
determine an average of the plurality of classification values; and
insert the average of the plurality of classification values into the neural network.

4. The apparatus of claim 1, wherein the highlight detection module is further to configure the processor to:
identify the set of information by selecting temporal information samples of the video segment;
determine a plurality of classification values for the temporal information samples;
determine an average of the plurality of classification values; and
insert the average of the plurality of classification values into the neural network.

5. The apparatus of claim 1, wherein the output module is further to configure the processor to:
determine a first playback speed for frames of one of the video segments in response to the highlight score of the one of the video segments being greater than a threshold value; and
determine a second playback speed for frames of the one of the video segments in response to the highlight score of the one of the video segments being less than the threshold value.

6. The apparatus of claim 1, wherein the output module is further to configure the processor to:
identify video segments having a highlight score greater than a threshold; and
combine at least a portion of the frames of the video segments identified as having the highlight score greater than a threshold value.

7. A system comprising:
a processor; and
a computer-readable media including instructions that, when executed by the processor, configure the processor to:
generate a first highlight score for a video segment of a plurality of video segments of an input video based at least in part on a first set of information associated with the video segment and a first neural network;
generate a second highlight score for the video segment based at least in part on a second set of information associated with the video segment and a second neural network;
generate a third highlight score for the video segment by merging the first highlight score and the second highlight score for the video segment; and
generate an output based at least on the third highlight scores for the plurality of video segments.

8. The system of claim 7, wherein the computer-readable media includes further instructions that, when executed by the processor, further configure the processor to:
generate a first highlight segment score by inserting first information associated with a previously identified highlight video segment from another video into the first neural network;
generate a first non-highlight segment score by inserting second information associated with a previously identified non-highlight video segment from the other video into the first neural network, wherein the first and second information have a format similar to the first set of information;
compare the first highlight segment score to the first non-highlight segment score;
adjust one or more parameters for the first neural network based at least in part on the comparing;
generate a second highlight segment score by inserting third information associated with a previously identified highlight video segment from the other video into the second neural network;
generate a second non-highlight segment score by inserting fourth information associated with a previously identified non-highlight video segment from the other video into the second neural network, wherein the third and fourth information have a format similar to the second set of information;
compare the second highlight segment score to the second non-highlight segment score; and
adjust one or more parameters for the second neural network based at least in part on the comparing.

9. The system of claim 7, wherein the computer-readable media includes further instructions that, when executed by the processor, further configure the processor to:
identify the first set of information by selecting spatial information samples of the video segment;
determine a plurality of classification values for the spatial information samples;
determine an average of the plurality of classification values;
insert the average of the plurality of classification values into the first neural network;
identify the second set of information by selecting temporal information samples of the video segment;
determine a plurality of classification values for the temporal information samples;
determine an average of the plurality of classification values for the temporal information samples; and
insert the average of the plurality of classification values for the temporal information samples into the second neural network.

10. The system of claim 7, wherein the computer-readable media includes further instructions that, when executed by the processor, further configure the processor to
determine a first playback speed for frames of one of the video segments in response to the third highlight score of the one of the video segments being greater than a first threshold value; and
determine a second playback speed for frames of the one of the video segments in response to the third highlight score of the one of the video segments being less than the first threshold value; or
identify video segments having a third highlight score greater than a second threshold value; and
combine at least a portion of the frames of the video segments identified as having the third highlight score greater than the second threshold value.

11. A method comprising:
generating, at a computing device, a first highlight score for a video segment of a plurality of video segments of an input video based at least in part on a first set of information associated with the video segment and a first neural network;
generating a second highlight score for the video segment based at least in part on a second set of information associated with the video segment and a second neural network;
generating a third highlight score for the video segment by merging the first highlight score and the second highlight score for the video segment; and
generating an output based at least on the third highlight scores for the plurality of video segments.

12. The method of claim 11, further comprising:
training the first neural network comprising:
generating a highlight segment score by inserting first information associated with a previously identified highlight video segment from another video into a first version of the first neural network;
generating a non-highlight segment score by inserting second information associated with a previously identified non-highlight video segment from the other video into a second version of the first neural network, wherein the first and second information have a format similar to the first set of information;
comparing the highlight segment score to the non-highlight segment score; and
adjusting one or more parameters for the first neural network based at least in part on the comparing.

13. The method of claim 11, further comprising:
training the second neural network comprising:
generating a highlight segment score by inserting first information associated with a previously identified highlight video segment from another video into a first version of the second neural network to generate a highlight segment score;
generating a non-highlight segment score by inserting second information associated with a previously identified non-highlight video segment from the other video into a second version of the second neural network, wherein the first and second information have a format similar to the second set of information;
comparing the highlight segment score to the non-highlight segment score; and
adjusting one or more parameters for the second neural network based at least in part on the comparing.

14. The method of claim 11, further comprising:
identifying the first set of information by selecting spatial information samples of the video segment;
determining a plurality of classification values for the spatial information samples;
determining an average of the plurality of classification values; and
inserting the average of the plurality of classification values into the first neural network.

15. The method of claim 11, further comprising:
identifying the second set of information by selecting temporal information samples of the video segment;
determining a plurality of classification values for the temporal information samples;
determining an average of the plurality of classification values; and
inserting the average of the plurality of classification values into the second neural network.

16. The method of claim 11, further comprising:
identifying the first set of information by selecting spatial information samples of the video segment;
determining a plurality of classification values for the spatial information samples;
determining an average of the plurality of classification values;
inserting the average of the plurality of classification values into the first neural network;
identifying the second set of information by selecting temporal information samples of the video segment;
determining a plurality of classification values for the temporal information samples;
determining an average of the plurality of classification values for the temporal information samples; and
inserting the average of the plurality of classification values for the temporal information samples into the second neural network.

17. The method of claim 11, further comprising:
determining a first playback speed for frames of one of the video segments in response to the third highlight score of the one of the video segments being greater than a threshold value; and
determining a second playback speed for frames of the one of the video segments in response to the third highlight score of the one of the video segments being less than the threshold value.

18. The method of claim 11, further comprising:
determining a playback speed for frames of one of the video segments based at least on the third highlight score of one of the video segments.

19. The method of claim 11, further comprising:
identifying video segments having a third highlight score greater than a threshold value; and
combining at least a portion of the frames of the video segments identified as having the third highlight score greater than the threshold value.

20. The method of claim 11, further comprising:
ordering at least a portion of the frames of at least a portion of the video segments based at least on the third highlight scores of the portion of the video segments.
